(19) United States
(12) Patent Application Publication
(10) Pub. No.: US 2005/0245247 A1
(43) Pub. Date: Nov. 3, 2005

(54) System and method for electronic business card service based on presence information

(75) Inventors: Ho-Sub Seo, Gunpo-si (KR); Ho-Won Jung, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/101,826

(22) Filed: Apr. 8, 2005

(30) Foreign Application Priority Data
Apr. 9, 2004 (KR) 2004-24536

(51) Int. Cl. H04M 3/00

(52) U.S. Cl. 455/418

(57) ABSTRACT

Disclosed are an electronic business card service system and a method for performing a vCard application of a client terminal. The electronic business card service system includes a presence server for providing presence information regarding at least one mobile terminal, an electronic business card server, a first mobile terminal for reporting change of presence information regarding the first mobile terminal to the presence server through a network, and a second mobile terminal for communicating with the presence server and the electronic business card server through the network, searching for the presence information by connecting to the presence server after displaying electronic business card information regarding other users read from electronic business card database, updating the electronic business card information using the searched presence information, and displaying the updated electronic business card information and the presence information on a screen.

### PRIORITY

This application claims priority to an application entitled “System and Method for Electronic Business Card Service Based on Presence Information” filed in the Korean Intellectual Property Office on Apr. 9, 2004 and assigned Serial No. 2004-24536, the contents of which are incorporated herein by reference.

### BACKGROUND OF THE INVENTION

1. Field of the Invention

The present invention relates to an electronic business card (versitcard) (hereinafter called a vCard) service system and a method for performing a vCard application of a client terminal connected to both a presence server and a vCard server through a wire/wireless network.

2. Description of the Related Art

The term “vCard” (versitcard) commonly refers to an electronic business card which is used for exchanging a information (e.g., personal information, business information, etc.) based on a conventional business card format. The term vCard also refers to a specification defining how the electronic business card information is exchanged and/or formatted. Hereinafter, the term vCard will refer generally to an electronic business card.

Generally, a terminal including a vCard service function stores information including addresses, phone numbers, and/or e-mail addresses of the other parties in the terminal's vCard database and can display this information to a user. The vCard information includes multimedia information and graphics such as pictures, company logos, web addresses, simple letter information, etc.

FIG. 1 is a flowchart illustrating an operation performed when a vCard application starts in a conventional mobile terminal.

In step 110, the mobile terminal reads vCard information regarding another user from a database (not shown) of the mobile terminal. Then, in step 130, the mobile terminal outputs the read vCard information on a screen.

FIG. 2 is a flowchart illustrating an operation performed when the vCard application is terminated in the conventional mobile terminal.

In step 220, when the mobile terminal intends to terminate the vCard application, the mobile terminal determines whether or not there is vCard information updated until a time point at which the mobile terminal intends to terminate the vCard application. In other words, this step determines whether or not a user updates the vCard information by editing data. If the mobile terminal determines that there is updated vCard information, the mobile terminal records the updated vCard information in its own database in step 240.

However, in the vCard application described above, the user must personally access the user's database and update corresponding information whenever vCard information regarding a certain target (wherein for the purpose of description, the term target as used herein refers to the other party) is changed which can be inconvenient. In addition, since the user cannot immediately recognize that vCard information regarding the other party has changed, the user cannot update the vCard information in real time and exactly determine whether or not current vCard information regarding the other party is the latest information.

In addition, when one user uses several terminals, it is inconvenient for the user to separately maintain and manage vCard information according to types of terminals. Herein, the terminals include portable phones, personal digital assistants (PDAs), laptops, etc.

Additionally, displaying only vCard information regarding the other party cannot enable a mobile terminal's user to easily determine current states (e.g., a communication state, a waiting state, a power off state, etc.) of the other party's terminal. Therefore, it is difficult for the user to select the most suitable method for communicating with the other party at any given time.

### SUMMARY OF THE INVENTION

Accordingly, the present invention has been made to solve the above-mentioned problems occurring in the prior art, and an object of the present invention is to provide a vCard service system and a method for performing a vcard application of a client terminal, which can automatically update vCard information regarding another party.

Another object of the present invention is to provide a vCard service system and a method for performing a vcard application of a client terminal, which can allow a user to properly communicate with another party by informing the user of current states regarding the other party.

Still another object of the present invention is to provide a vCard service system and a method for performing a vCard application of a client terminal, which can allow different terminals used by an identical user to share identical vCard information by providing server synchronization.

To accomplish the above and other objects, there is provided an electronic business card service system including a presence server for providing presence information regarding at least one mobile terminal, an electronic business card database server, a first mobile terminal for reporting change of presence information regarding the first mobile terminal to the presence server through a network, and a second mobile terminal for communicating with the presence server and the electronic business card database server through the network, searching for the presence information by connecting to the presence server after displaying electronic business card information regarding other users read from electronic business card database, updating the electronic business card information using the searched presence information, and displaying the updated electronic business card information and the presence information on a screen.

According to another aspect of the present invention, there is provided a method for performing an electronic business card application by a mobile communicating with a presence server and an electronic business card database server through a network, the mobile terminal including an electronic business card database, the method including the steps of displaying electronic business card information regarding other users read from the electronic business card database, after the electronic business card information is displayed, connecting to the presence server so as to search for presence information regarding mobile terminals of the users and updating the electronic business card information based on the searched presence information, and displaying the updated electronic business card information and the presence information on a screen.

### BRIEF DESCRIPTION OF THE DRAWINGS

The above and other objects, features and advantages of the present invention will be more apparent from the following detailed description taken in conjunction with the accompanying drawings, in which:

FIG. 1 is a flowchart illustrating an operation performed when a vCard application starts in a conventional mobile terminal;

FIG. 2 is a flowchart illustrating an operation performed when the vCard application is terminated in a conventional mobile terminal;

FIG. 3 is a block diagram illustrating a structure of a vCard service system according to a preferred embodiment of the present invention;

FIG. 4 is a flowchart illustrating an operation performed when a vCard application starts in a mobile terminal according to a preferred embodiment of the present invention;

FIG. 5 is a flowchart illustrating an operation performed when a vCard application is terminated in a mobile terminal according to a preferred embodiment of the present invention; and

FIG. 6 is a flowchart illustrating a synchronization requesting process of a vCard application in a mobile terminal according to a preferred embodiment of the present invention.

### DETAILED DESCRIPTION OF THE PREFERRED EMBODIMENT

Hereinafter, a preferred embodiment of the present invention will be described in detail with reference to the accompanying drawings. Note that the same or similar components in drawings are designated by the same reference numerals as far as possible although they are shown in different drawings. In the following description of the present invention, a detailed description of known functions and configurations incorporated herein will be omitted when it may make the subject matter of the present invention unclear.

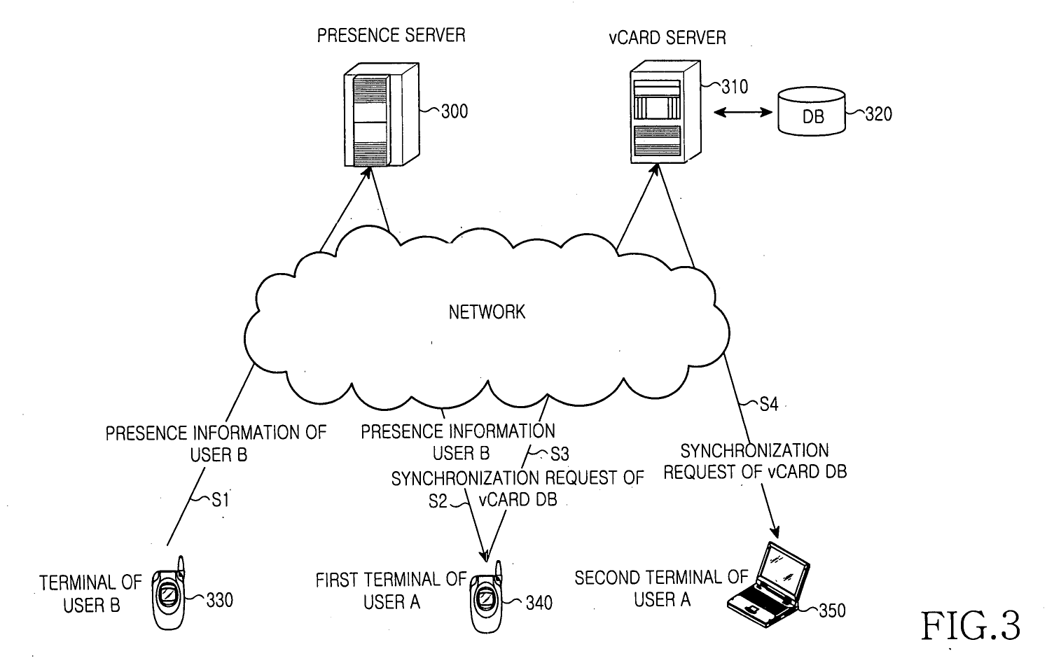

FIG. 3 is a view illustrating a structure of a vcard service system according to a preferred embodiment of the present invention.

A presence server 300 (i.e., a “messenger server”) provides presence information regarding at least one mobile terminal. The presence information includes data such as a client identification, a uniform resource identifier (URI), a client state (on-line state or off-line state), e-mail addresses, a client schedule, a business card, etc. corresponding to each client.

A vCard server 310 is connected with a vCard database 320 and provides vCard services.

A first mobile terminal 330 reports change of its own presence information to the presence server 300 through a wire/wireless network. As shown in FIG. 3, the first mobile terminal corresponds to a terminal 330 of a user B. Reference numeral S1 represents an operation in which the terminal 330 transmits its own presence information to the presence server 300. The terminal 330 transmits its the terminal's presence information as described above when the terminal's information (e.g., information regarding change from an off-line state into an on-line state or information regarding change of its own schedule) has changed.

A second mobile terminal communicates with the presence server 300 and the vCard server 310 through the wire/wireless network, displays vCard information regarding another user read from the vCard database 320, searches for presence information regarding the first mobile terminal by connecting to the presence server 300, updates the vCard information using the searched presence information, and displays the updated vCard information and the presence information on a screen of the second mobile terminal. In addition, if a termination time point of a vCard application is detected or if user's synchronization request is detected, the second mobile terminal determines whether vCard information which has been updated until a time point at which the termination time point is detected or a time point at which the user's synchronization request is detected exists. If the updated vCard information exists, the second mobile terminal requests synchronization to the vCard server 310 so as to allow the vCard server 310 to update the vCard data base 320. The second mobile terminal corresponds to a first terminal 340 of a user A. Herein, reference numeral S2 represents an operation in which the presence server 300 transmits the presence information regarding user B to the first terminal 340. Reference numeral S3 represents an operation in which the first terminal 340 requests vCard database synchronization to the vCard server 310. Herein, this vCard database synchronization implies an operation of updating data of the vCard database 320 connected to the vCard server 310.

A third mobile terminal requests synchronization to the vCard server 310 so as to update its own database using vCard information received from the vcard server 310. The third mobile terminal corresponds to a second terminal 350 of the user A. Reference numeral S4 represents an operation that the vCard server transmits data for vCard database synchronization to the second terminal 350. This vCard database synchronization refers to an operation of updating data in a database (not shown) of the second terminal 350.

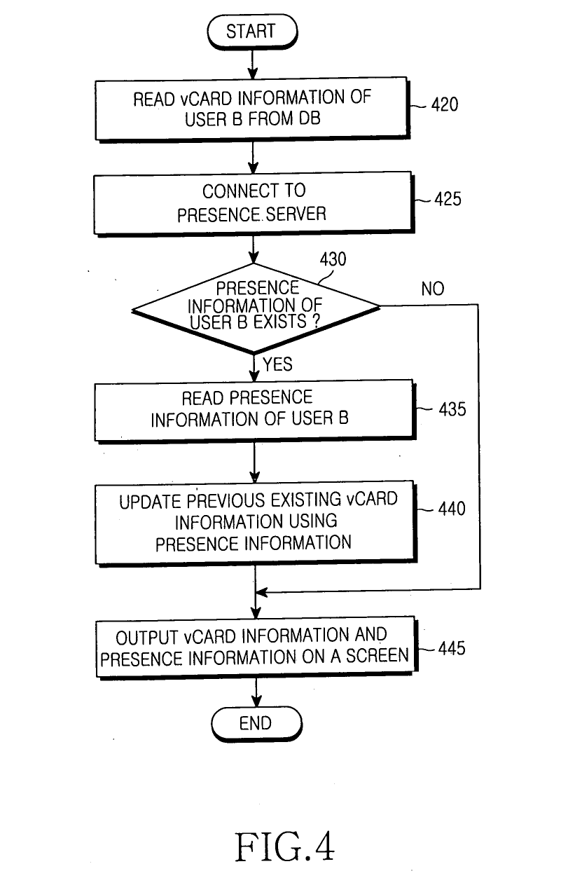

FIG. 4 is a flowchart illustrating a starting operation of the vCard application according to a preferred embodiment of the present invention.

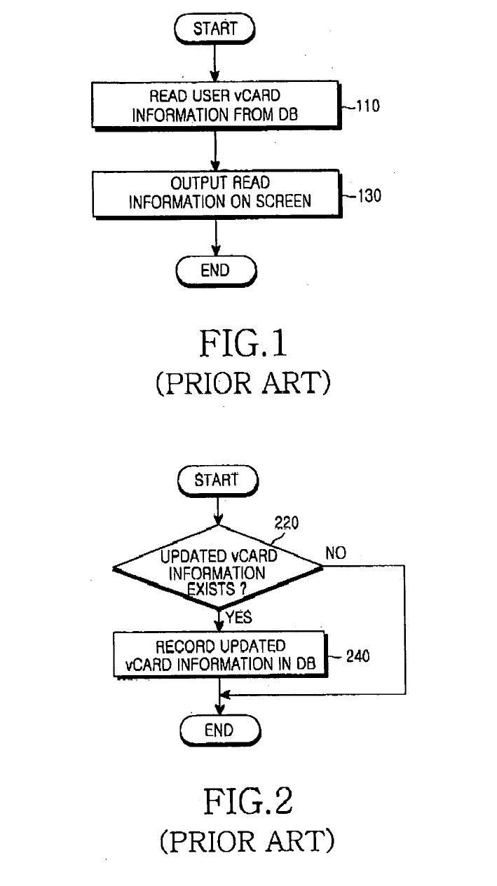

Hereinafter, on the assumption that a mobile terminal corresponds to the first terminal 340 of the user A, and the other party corresponds to the user B using a terminal marked as reference numeral 330, the embodiment will be described by employing the case shown in FIG. 1.

In step 420, when the mobile terminal initially executes the vCard application, the mobile terminal reads vCard information regarding the user B from its own database (not shown). In step 425, the mobile terminal is connected to the presence server 300. Then, in step 430, the mobile terminal determines whether presence information regarding the user B exists in the presence server 300. If the presence information regarding the user B exists in the presence server 300, the mobile terminal reads the presence information regarding the user B in step 435. In step 440, the mobile terminal updates existing vCard information regarding the user B in its own database using the presence information. If the presence information regarding the user B does not exist in the presence server 300 in step 430 or if the update is terminated in step 440, the mobile terminal displays the updated vCard information and the presence information on a display in step 445.

Although a case in which the mobile terminal reads only vCard information regarding the user B as shown in FIG. 4 is described for the purpose of description, it is envisioned that the mobile terminal can read and subsequently display information regarding a plurality of targets registered in the database at the same time, request corresponding presence information, and update corresponding vCard information. In order to confirm presence information regarding the targets, the mobile terminal transmits server IDs of corresponding targets when making contact with the presence server. This allows the presence server to find and provide presence information regarding a user corresponding to each server ID.

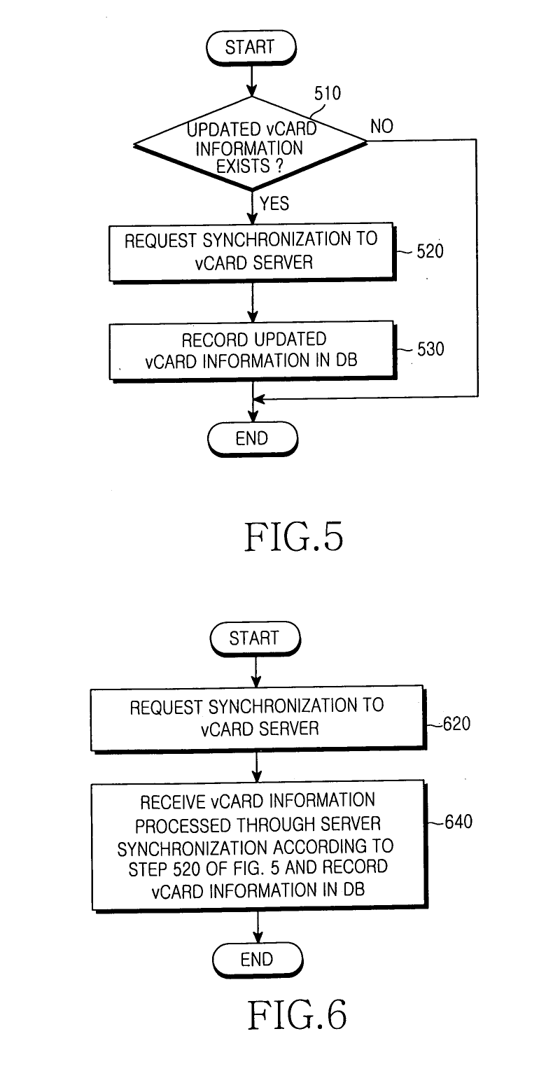

FIG. 5 is a flowchart illustrating a terminating operation of the vCard application according to a preferred embodiment of the present invention.

In step 510, when the mobile terminal intends to terminate the vCard application, the mobile terminal determines whether updated vCard information exits. If the mobile terminal has performed the operation described with reference to FIG. 4 then updated vCard information may exist.

If it is determined that the updated vCard information exists as a result of the determination in step 510, the mobile terminal requests synchronization to the vCard server 310 in step 520. Then, the mobile terminal records the updated vCard information in its own database in step 530.

If the mobile terminal requests the synchronization to the vCard server 310 so as to make the vCard server 310 update data of the database 310 as described above, and then, if the user A intends to use another terminal (e.g., the second terminal 350 of the user A), the second terminal 350 requests vCard information synchronization to the vCard server 310 so as to automatically update its own database by using the latest vCard information.

FIG. 6 is a flowchart illustrating a synchronization requesting process in the vCard application according to a preferred embodiment of the present invention.

On the assumption that the above described mobile terminal performing the operations as described with reference to FIGS. 4 and 5 will now be referred to as the second mobile terminal for the purpose of description, a mobile terminal performing an operation of FIG. 6 may become the third mobile terminal. For example, a case of the synchronization request shown in FIG. 6 may include a case in which the power of a mobile terminal is turned on after the power of the mobile terminal is turned off during a predetermined time interval. If this embodiment employs a case shown in FIG. 1, the second mobile terminal corresponds to the first terminal 340 of the user A, and the third mobile terminal corresponds to the second terminal 350 of the user A.

In step 620, the third mobile terminal requests synchronization to the vCard server 310. Herein, this synchronization request is different from that performed in step 520 of FIG. 5. In other words, the former synchronization request corresponds to a case in which the vCard server 310 is requested to update presence information regarding the user B stored in the database 320 of the vCard server 310, and the latter corresponds to a case in which the vCard server 310 is requested to provide the updated presence information regarding the user B. Accordingly, the former synchronization request is named “server synchronization”, and the latter synchronization is named “client synchronization”.

In step 640, the second mobile terminal receives vCard information processed through the server synchronization according to step 520 of FIG. 5 from the server 310 and stores the vCard information in its own database. Herein, the vCard information processed through the server synchronization according to step 520 of FIG. 5 denotes vCard information updated when the vCard server 310 updates corresponding vCard information according to synchronization request to the vCard server 310 from the third mobile terminal.

As described above, according to the present invention, it is possible to overcome a disadvantage in that a user must personally modify vCard information whenever information regarding the other party is changed. In addition, it is possible to allow the user to select the most suitable communication device (e.g., portable phone, wire telephone, e-mail, IM, etc.) when the user intends to communicate with the other party by showing presence information regarding the other party in addition to vCard information. In addition, when the user has several terminals and when information regarding the other party is changed, it is convenient for the user that the latest vCard information is automatically updated without modification by the user for corresponding information regarding each terminal.

While the invention has been shown and described with reference to certain preferred embodiments thereof, it will be understood by those skilled in the art that various changes in form and details may be made therein without departing from the spirit and scope of the invention. Consequently, the scope of the invention should not be limited to the embodiments, but should be defined by the appended claims and equivalents thereof.

1. An electronic business card service system comprising:
a presence server for providing presence information regarding at least one mobile terminal;
an electronic business card server;
a first mobile terminal for reporting change of presence information regarding the first mobile terminal to the presence server through a network; and
a second mobile terminal for communicating with the presence server and the electronic business card server through the network, searching for the presence information by connecting to the presence server after displaying electronic business card information regarding other users read from the second mobile terminal's database, updating the electronic business card information using the searched presence information, and displaying the updated electronic business card information and the presence information on a screen.

2. The electronic business card service system as claimed in claim 1, wherein if the second mobile terminal detects a user's synchronization request or a time point at which an electronic business card application is terminated, the second mobile terminal determines whether there is electronic business card information updated until a time point at which the second mobile terminal detects the user's synchronization request or a time point at which the second mobile terminal detects the terminated time point, and, if the updated electronic business card information exists, the second mobile terminal requests synchronization to the electronic business card server so as to update a database of the electronic business card.

3. The electronic business card service system as claimed in claim 1, further comprising a third mobile terminal which requests synchronization to the electronic business card server and updates a database of the third mobile terminal using electronic business card information received from the electronic business card server.

4. A method for performing an electronic business card application by a mobile terminal by communicating with a presence server and an electronic business card server through a network, the mobile terminal including an electronic business card database, the method comprising the steps of:
displaying electronic business card information regarding other users read from the electronic business card database;
after the electronic business card information is displayed, connecting to the presence server so as to search for presence information regarding mobile terminals of the users and updating the electronic business card information based on the presence information,
displaying the updated electronic business card information and the presence information on a screen.

5. The method as claimed in claim 4, further comprising the steps of:
if a time point at which the electronic business card application is terminated is detected or a user's synchronization request is detected, determining whether or not there is electronic business card information updated until a time point at which the user's synchronization request is detected or a time point at which the terminated time point is detected; and
if the updated electronic business card information exists, requesting synchronization to the electronic business card server so as to update a database of the electronic business card server.

6. The method as claimed in claim 5, further comprising a step of recording the updated electronic business card information in the electronic business card database of the mobile terminal.
